(19) United States
(12) Patent Application Publication
(10) Pub. No.: US 2019/0324333 A1
(43) Pub. Date: Oct. 24, 2019

(54) DISPLAY DEVICE AND METHOD OF MANUFACTURING DISPLAY DEVICE

(71) Applicant: Mitsubishi Electric Corporation, Tokyo (JP)

(72) Inventor: Manabu TANAHARA, Tokyo (JP)

(73) Assignee: Mitsubishi Electric Corporation, Tokyo (JP)

(21) Appl. No.: 16/371,151

(22) Filed: Apr. 1, 2019

(30) Foreign Application Priority Data
Apr. 18, 2018 (JP) 2018-079966

(51) Int. Cl. G02F 1/1362; G02F 1/13; G02F 1/1347; G02F 1/1333; G02F 1/1345; G02F 1/1343

(52) U.S. Cl. CPC G02F 1/136204; G02F 1/1326; G02F 1/13471; G02F 1/1368; G02F 1/13452; G02F 1/13439; G02F 2001/136218; G02F 1/133345

(57) ABSTRACT

According to the present invention, a display device includes a display panel, and a parallax barrier shutter panel. The parallax barrier shutter panel is provided to be opposed to the display panel. The parallax barrier shutter panel includes a plurality of first transparent electrodes, a drive IC, and an FPC. The plurality of first transparent electrodes are provided at regular intervals. The drive IC is configured to control a voltage to be applied to each of the plurality of first transparent electrodes. The FPC includes an FPC terminal electrically connected to an input terminal of the drive IC. At least one of each of the plurality of first transparent electrodes, an output terminal of the drive IC, and the FPC terminal is electrically connected to a short ring.

### BACKGROUND OF THE INVENTION

### Field of the Invention

The present invention relates to a display device including a parallax barrier shutter panel, and a method of manufacturing the display device.

### Description of the Background Art

A parallax barrier method has hitherto been known as a naked-eye stereoscopic image display method, with which an observer can stereoscopically see an image with the naked eye without the need of special eyeglasses. A display device of the parallax barrier method includes a parallax barrier panel also referred to as a transmission display device, barrier generation means for generating a barrier having a shape of a plurality of stripes through electronic control, and a display screen disposed behind the parallax barrier panel. The display device of the parallax barrier method displays a multidirectional image that corresponds to a parallax barrier and in which left-eye images and right-eye images are alternately arrayed. With this configuration, the display device of the parallax barrier method realizes stereoscopic view.

In such a display device, the barrier is electronically generated, and a shape, a position, and density of the generated barrier can be freely changeably controlled. Thus, the display device can be used as a two-dimensional image display device or a stereoscopic image display device (see Japanese Patent Application Laid-Open No. 2016-191890, for example). The shape of the barrier includes the number of stripes, the width of each stripe, and an interval of adjacent stripes.

Further, in order to enhance a manufacturing yield of a parallax barrier panel, a technology of connecting a periphery routing wire to both ends of a barrier electrode as a countermeasure against disconnection of the periphery routing wire due to static electricity or the like is disclosed (see Japanese Patent Application Laid-Open No. 2016-191894, for example).

Japanese Patent Application Laid-Open No. 2016-191894 enhances redundancy against disconnection of the periphery routing wire because the periphery routing wire is connected to both the ends of the barrier electrode, but is insufficient as a countermeasure against disconnection due to static electricity. Accordingly, there is a problem in reduction in a manufacturing yield because of a factor of disconnection due to static electricity. For example, when the periphery routing wire connected to both the ends of the barrier electrode is disconnected, or when the periphery routing wire is disconnected at two or more positions in a display area, such disconnection is visibly recognized as a disconnection failure. Further, a disconnection failure occurs also when a terminal portion breaks down due to static electricity. Japanese Patent Application Laid-Open No. 2016-191890 also has a problem in reduction in a manufacturing yield because a countermeasure against disconnection due to static electricity is insufficient.

### SUMMARY

The present invention has an object to provide a display device capable of enhancing a manufacturing yield, and a method of manufacturing the display device.

According to the present invention, a display device includes a display panel, and a parallax barrier shutter panel. The parallax barrier shutter panel is provided to be opposed to the display panel. The parallax barrier shutter panel includes a plurality of transparent electrodes, a drive IC, and an FPC. The plurality of transparent electrodes are provided at regular intervals. The drive IC is configured to control a voltage to be applied to each of the plurality of transparent electrodes. The FPC includes an FPC terminal electrically connected to an input terminal of the drive IC. At least one of each of the plurality of transparent electrodes, an output terminal of the drive IC, and the FPC terminal is electrically connected to a short ring.

The display device includes a display panel, and a parallax barrier shutter panel. The parallax barrier shutter panel is provided to be opposed to the display panel. The parallax barrier shutter panel includes a plurality of transparent electrodes, a drive IC, and an FPC. The plurality of transparent electrodes are provided at regular intervals. The drive IC is configured to control a voltage to be applied to each of the plurality of transparent electrodes. The FPC includes an FPC terminal electrically connected to an input terminal of the drive IC. At least one of each of the plurality of transparent electrodes, an output terminal of the drive IC, and the FPC terminal is electrically connected to a short ring. Therefore, a manufacturing yield can be enhanced.

According to the present invention, a display device includes a display panel, and a parallax barrier shutter panel. The parallax barrier shutter panel is provided to be opposed to the display panel. The parallax barrier shutter panel includes a transparent substrate, an electric-field shield electrode, an insulation layer, and a plurality of transparent electrodes. The electric-field shield electrode is provided on the transparent substrate. The insulation layer is provided to cover the electric-field shield electrode. The plurality of transparent electrodes are provided on the insulation layer at regular intervals.

The display device includes a display panel, and a parallax barrier shutter panel. The parallax barrier shutter panel is provided to be opposed to the display panel. The parallax barrier shutter panel includes a transparent substrate, an electric-field shield electrode, an insulation layer, and a plurality of transparent electrodes. The electric-field shield electrode is provided on the transparent substrate. The insulation layer is provided to cover the electric-field shield electrode. The plurality of transparent electrodes are provided on the insulation layer at regular intervals. Therefore, a manufacturing yield can be enhanced.

According to the present invention, a method of manufacturing a display device includes the following steps (a) and (b). The step (a) is to prepare a display panel. The step (b) is to provide a parallax barrier shutter panel to be opposed to the display panel. The step (b) further includes the following steps (c) to (g). The step (c) is to form a plurality of transparent electrodes on a transparent substrate at regular intervals. The step (d) is to form an input terminal and an output terminal of a drive IC on the transparent substrate. The drive IC is configured to control a voltage to be applied to each of the plurality of transparent electrodes. The step (e) is to form an FPC terminal on the transparent substrate. The FPC terminal is electrically connected to the input terminal of the drive IC. The step (f) is to electrically connect a short ring formed on the transparent substrate outside the parallax barrier shutter panel and at least one of each of the plurality of transparent electrodes, the output terminal of the drive IC, and the FPC terminal. The step (g) is to cut off the electrical connection made in the step (f), and to remove the parallax barrier shutter panel from the transparent substrate.

The method of manufacturing a display device includes the following steps (a) and (b). The step (a) is to prepare a display panel. The step (b) is to provide a parallax barrier shutter panel to be opposed to the display panel. The step (b) further includes the following steps (c) to (g). The step (c) is to form a plurality of transparent electrodes on a transparent substrate at regular intervals. The step (d) is to form an input terminal and an output terminal of a drive IC on the transparent substrate. The drive IC is configured to control a voltage to be applied to each of the plurality of transparent electrodes. The step (e) is to form an FPC terminal on the transparent substrate. The FPC terminal is electrically connected to the input terminal of the drive IC. The step (f) is to electrically connect a short ring formed on the transparent substrate outside the parallax barrier shutter panel and at least one of each of the plurality of transparent electrodes, the output terminal of the drive IC, and the FPC terminal. The step (g) is to cut off the electrical connection made in the step (f), and to remove the parallax barrier shutter panel from the transparent substrate. Therefore, a manufacturing yield can be enhanced.

According to the present invention, a method of manufacturing a display device includes the following steps (a) and (b). The step (a) is to prepare a display panel. The step (b) is to provide a parallax barrier shutter panel to be opposed to the display panel. The step (b) further includes the following steps (c) to (h). The step (c) is to form a plurality of transparent electrodes on a first transparent substrate at regular intervals. The step (d) is to form an input terminal and an output terminal of a drive IC on the first transparent substrate. The drive IC is configured to control a voltage to be applied to each of the plurality of transparent electrodes. The step (e) is to form an FPC terminal on the first transparent substrate. The FPC terminal is electrically connected to the input terminal of the drive IC. The step (f) is to form a second transparent electrode on a second transparent substrate opposed to the first transparent substrate. The step (g) is to electrically connect the second transparent electrode and at least one of the input terminal of the drive IC, the output terminal of the drive IC, and the FPC terminal. The step (h) is to cut off the electrical connection made in the step (g), and to remove the parallax barrier shutter panel from the first transparent substrate and the second transparent substrate.

The method of manufacturing a display device includes the following steps (a) and (b). The step (a) is to prepare a display panel. The step (b) is to provide a parallax barrier shutter panel to be opposed to the display panel. The step (b) further includes the following steps (c) to (h). The step (c) is to form a plurality of transparent electrodes on a first transparent substrate at regular intervals. The step (d) is to form an input terminal and an output terminal of a drive IC on the first transparent substrate. The drive IC is configured to control a voltage to be applied to each of the plurality of transparent electrodes. The step (e) is to form an FPC terminal on the first transparent substrate. The FPC terminal is electrically connected to the input terminal of the drive IC. The step (f) is to form a second transparent electrode on a second transparent substrate opposed to the first transparent substrate. The step (g) is to electrically connect the second transparent electrode and at least one of the input terminal of the drive IC, the output terminal of the drive IC, and the FPC terminal. The step (h) is to cut off the electrical connection made in the step (g), and to remove the parallax barrier shutter panel from the first transparent substrate and the second transparent substrate. Therefore, a manufacturing yield can be enhanced.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross-sectional view illustrating one example of a configuration of a display device according to an underlying technology.

FIG. 2 is a plan view illustrating one example of a configuration of a parallax barrier shutter panel according to the underlying technology.

FIG. 3 is a diagram for explaining the parallax barrier shutter panel according to the underlying technology.

FIG. 4 is a plan view illustrating one example of a configuration of a first transparent substrate according to the underlying technology.

FIG. 5 is a plan view illustrating one example of a configuration of the first transparent substrate according to a first preferred embodiment of the present invention.

FIG. 6 is a plan view illustrating one example of a configuration of a TFT array substrate according to the first preferred embodiment of the present invention.

FIG. 7 is a plan view illustrating one example of a configuration of the first transparent substrate according to the first preferred embodiment of the present invention.

FIG. 8 is a plan view illustrating one example of a configuration of the first transparent substrate according to the first preferred embodiment of the present invention.

FIG. 9 is a plan view illustrating one example of a configuration of the first transparent substrate according to the first preferred embodiment of the present invention.

FIG. 10 is a plan view illustrating one example of a configuration of the first transparent substrate according to a second preferred embodiment of the present invention.

FIG. 11 is a plan view illustrating one example of a configuration of the first transparent substrate according to a third preferred embodiment of the present invention.

FIG. 12 is a plan view illustrating one example of a configuration of a spark gap according to the third preferred embodiment of the present invention.

FIG. 13 is a plan view illustrating one example of a configuration of the first transparent substrate according to a fourth preferred embodiment of the present invention.

FIG. 14 is a cross-sectional view illustrating one example of a configuration of the first transparent substrate according to a fifth preferred embodiment of the present invention.

FIG. 15 is a cross-sectional view illustrating one example of a configuration of the parallax barrier shutter panel according to a sixth preferred embodiment of the present invention.

FIG. 16 is a plan view illustrating one example of a configuration of the first transparent substrate according to a seventh preferred embodiment of the present invention.

FIG. 17 is a circuit diagram illustrating one example of a configuration of a non-linear element according to the seventh preferred embodiment of the present invention.

FIG. 18 is a cross-sectional view illustrating one example of a configuration of the parallax barrier shutter panel according to the seventh preferred embodiment of the present invention.

FIG. 19 is a plan view illustrating one example of a configuration of the first transparent substrate according to an eighth preferred embodiment of the present invention.

FIG. 20 is a plan view illustrating one example of a configuration of the first transparent substrate according to the eighth preferred embodiment of the present invention.

FIG. 21 is a plan view illustrating one example of a configuration of the first transparent substrate according to the eighth preferred embodiment of the present invention.

### DESCRIPTION OF THE PREFERRED EMBODIMENTS

Preferred embodiments of the present invention will be described below with reference to the drawings.

### <Underlying Technology>

An underlying technology that is a technology underlying the present invention will be described.

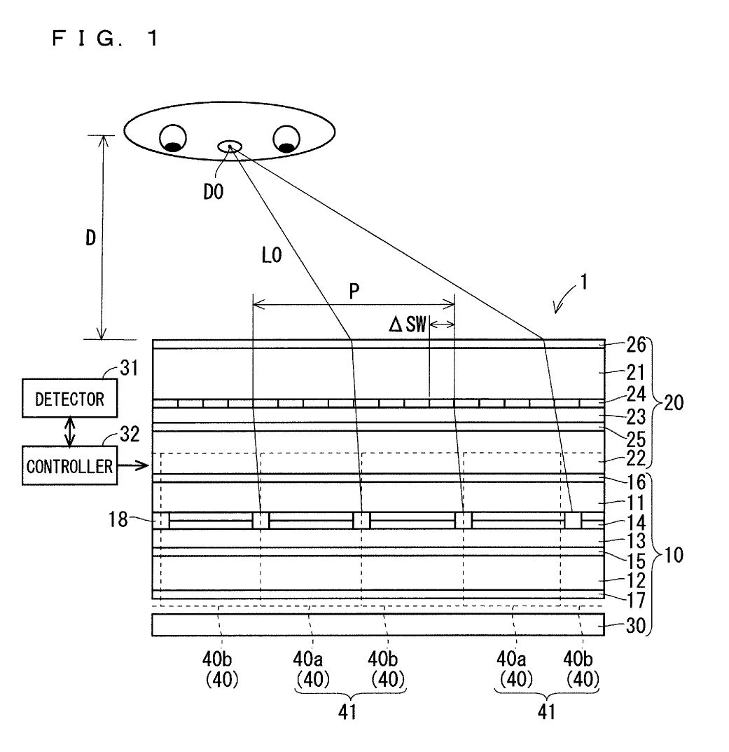

FIG. 1 is a cross-sectional view illustrating one example of a configuration of a display device 1 according to an underlying technology. In FIG. 1, a long-side direction of the drawing sheet corresponds to a depth direction of the display device 1, a short-side direction of the drawing sheet corresponds to a horizontal direction of the display device 1, and a depth direction of the drawing sheet corresponds to a vertical direction of the display device 1.

The display device 1 can simultaneously display two images, namely, a right-eye image that is a parallax image for the right eye of an observer, and a left-eye image that is a parallax image for the left eye of the observer. The observer can visibly recognize a stereoscopic image of the display device 1 with the naked eye without using special eyeglasses, or the display device 1 can display different images in different observation directions. Specifically, the display device 1 can be applied to a naked-eye stereoscopic display device of the former case, or to a dual-screen display device of the latter case. The dual-screen display device is also referred to as a dual-view display device. The following description will be given on an assumption that the display device 1 is a naked-eye stereoscopic display device.

As illustrated in FIG. 1, a controller 32 is connected to the display device 1, and a detector 31 is connected to the controller 32. The detector 31 detects a position of the head or the like of the observer. The detector 31 can detect a motion of the head or the like of the observer by detecting the position of the head or the like of the observer every fixed time period. The controller 32 integrally controls the display device 1 and the detector 31 based on a detection result obtained by the detector 31, an image signal, etc.

As illustrated in FIG. 1, the display device 1 includes a display panel 10, and a parallax barrier shutter panel 20 disposed on the display panel 10. The parallax barrier shutter panel 20 is also referred to as an optical guide member.

The display panel 10 is a matrix display panel. Examples of the display panel 10 include an organic electroluminescent (EL) panel, a plasma display panel, a liquid crystal display panel, etc. Note that, if a liquid crystal display panel is used as the display panel 10, the parallax barrier shutter panel 20 may be disposed on the lower side the display panel 10.

FIG. 1 illustrates one example of a case where a liquid crystal display panel is used as the display panel 10. The display panel 10 includes two transparent substrates 11 and 12, and a liquid crystal layer 13 interposed between the transparent substrates 11 and 12. A sub-pixel transparent electrode 14 is formed on the liquid crystal layer 13 side of the transparent substrate 11. The sub-pixel transparent electrode 14 is formed to extend in a stripe shape in the depth direction. A counter-transparent electrode 15 is formed on the liquid crystal layer 13 side of the transparent substrate 12. The counter-transparent electrode 15 is formed on the entire surface on the transparent substrate 12. The sub-pixel transparent electrode 14 and the counter-transparent electrode 15 apply an electric field to the liquid crystal layer 13 to drive the liquid crystal layer 13.

An intermediate polarizing plate 16 is provided on a side of the transparent substrate 11 opposite to the liquid crystal layer 13, and a back-surface polarizing plate 17 is provided on a side of the transparent substrate 12 opposite to the liquid crystal layer 13. A backlight 30 is provided on a side of the back-surface polarizing plate 17 opposite to the transparent substrate 12.

Note that, although not illustrated in FIG. 1, an alignment film that aligns the liquid crystal layer 13 in a certain direction is provided on each surface of the transparent substrate 11 and the transparent substrate 12 on the liquid crystal layer 13 side. Further, the configuration of the display panel 10 is not limited to the configuration illustrated in FIG. 1. For example, in FIG. 1, the positions of the sub-pixel transparent electrode 14 and the counter-transparent electrode 15 may be interchanged.

A plurality of sub-pixels 40 are disposed on the display panel 10. Among the sub-pixels 40, sub-pixels 40 that display the right-eye image are referred to as right-eye sub-pixels 40a. Among the sub-pixels 40, sub-pixels 40 that display the left-eye image are referred to as left-eye sub-pixels 40b. The right-eye sub-pixels 40a and the left-eye sub-pixels 40b are alternately disposed in the short-side direction. A light blocking wall 18 is provided between the right-eye sub-pixel 40a and the left-eye sub-pixel 40b. In other words, the right-eye sub-pixels 40a and the left-eye sub-pixels 40b are interposed between the light blocking walls 18.

The width of each of the right-eye sub-pixels 40a and the left-eye sub-pixels 40b in the short-side direction is equal to each other, or substantially equal to each other. A pair of adjacent right-eye sub-pixel 40a and left-eye sub-pixel 40b forms a sub-pixel pair 41 that displays two images different on the right and left sides, i.e., the right-eye image and the left-eye image. The sub-pixel pairs 41 are arrayed at regular pitches in the short-side direction in the display panel 10. Further, the sub-pixel pairs 41 are arrayed in the depth direction as well as the short-side direction.

In FIG. 1, a reference parallax barrier pitch P is defined as a reference pitch of the sub-pixel pair 41 in the short-side direction. The reference parallax barrier pitch P is set such that imaginary rays of light LO converge at a design visible recognition point DO. Each of the rays of light LO is emitted from the center of the light blocking wall 18 located between the right-eye sub-pixel 40a and the left-eye sub-pixel 40b that form the sub-pixel pair 41, and passes through the center of the reference parallax barrier pitch P that corresponds to this sub-pixel pair 41. The design visible recognition point DO is located away from the display device 1 in an upper direction by a design observation distance D. Note that, for the sake of facilitating description, the reference parallax barrier pitch P is herein regarded as the sum of the width of the right-eye sub-pixel 40a in the short-side direction and the width of the left-eye sub-pixel 40b in the short-side direction. Description concerning optimization of the design observation distance D is herein omitted.

The parallax barrier shutter panel 20 includes a first transparent substrate 21, a second transparent substrate 22, and a liquid crystal layer 23 interposed between the first transparent substrate 21 and the second transparent substrate 22.

A plurality of first transparent electrodes 24 that extend in the depth direction in a stripe shape are formed on the liquid crystal layer 23 side of the first transparent substrate 21. An even number of first transparent electrodes 24 each having a width of ΔSW are disposed within the reference parallax barrier pitch P. In the example of FIG. 1, eight first transparent electrodes 24 are disposed within the reference parallax barrier pitch P. Note that, unless otherwise particularly noted, each first transparent electrode 24 is electrically insulated from each other.

A second transparent electrode 25 that extends at least in the short-side direction is formed on the liquid crystal layer 23 side of the second transparent substrate 22. A plurality of the second transparent electrodes 25 each having a width of the reference parallax barrier pitch P may be arrayed in the depth direction, or the second transparent electrode 25 may be disposed on the entire surface of the second transparent substrate 22. In FIG. 1, the second transparent electrode 25 is disposed on the entire surface of the second transparent substrate 22.

The first transparent electrode 24 and the second transparent electrode 25 drive the liquid crystal layer 23 by applying an electric field to the liquid crystal layer 23. As a drive mode of the liquid crystal layer 23, Twisted Nematic (TN), Super-Twisted Nematic (STN), In-Plane Switching, Vertical Alignment (VA), Optically Compensated Bend (OCB), or the like may be used.

A display-surface polarizing plate 26 is provided on the upper side of the first transparent substrate 21. Further, although a polarizing plate is provided also on the lower side of the second transparent substrate 22, the intermediate polarizing plate 16 is used to serve also as this polarizing plate. Note that, although the first transparent substrate 21 is disposed on the upper side of the second transparent substrate in FIG. 1, the disposition of the first transparent substrate 21 and the second transparent substrate may be interchanged.

A voltage is selectively applied to each of the first transparent electrode 24 and the second transparent electrode 25. With this, the parallax barrier shutter panel 20 can be switched between a light transmitting state and a light blocking state in each width of the first transparent electrode 24 in the short-side direction. An optical aperture in the parallax barrier shutter panel 20, which can be switched between the light transmitting state and the light blocking state in each width of the first transparent electrode 24 through electrical control, is hereinafter referred to as a sub-aperture.

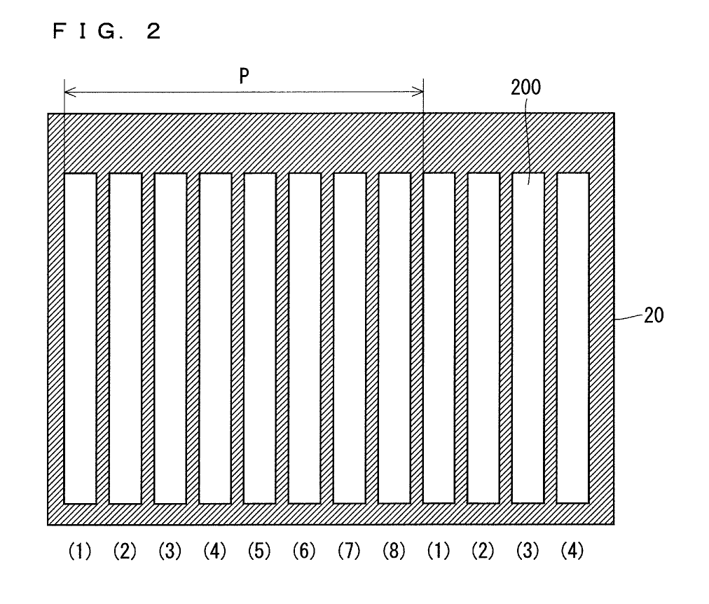

The sub-apertures are formed at positions corresponding to the respective plurality of first transparent electrodes. Since eight first transparent electrodes 24 are arrayed in the short-side direction within the reference parallax barrier pitch P in the parallax barrier shutter panel 20, eight sub-apertures 200 are arrayed in the short-side direction within the reference parallax barrier pitch P as illustrated in FIG. 2. Specifically, the disposition positions of the first transparent electrodes 24 and the disposition positions of the sub-apertures 200 correspond to each other.

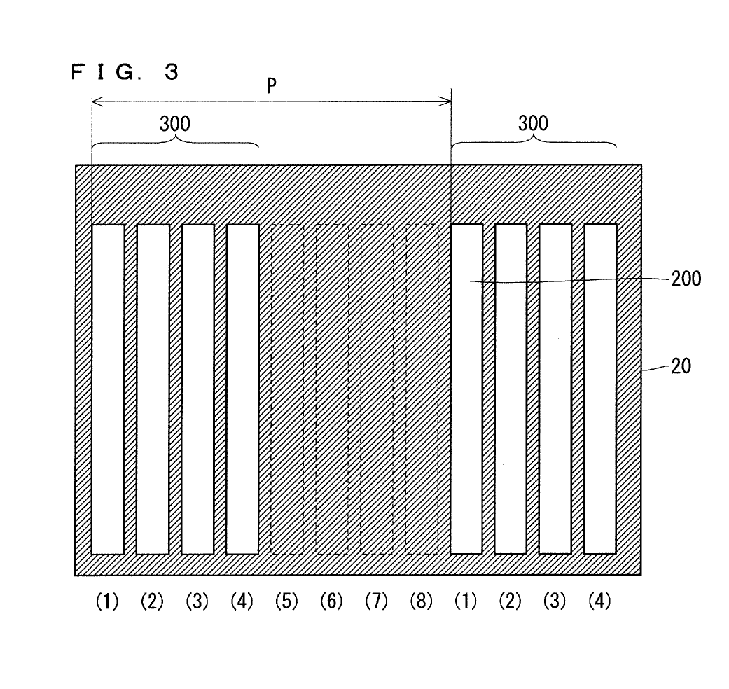

Although all of the sub-apertures 200 are opened to be brought into the light transmitting state in FIG. 2, each sub-aperture 200 of the parallax barrier shutter panel 20 can be switched between the light transmitting state and the light blocking state by controlling a voltage to be applied to the first transparent electrode 24. For example, FIG. 3 illustrates an example in which a half of the eight sub-apertures 200 denoted by (1) to (8) within the reference parallax barrier pitch P, i.e., four sub-apertures 200 denoted by (5) to (8), are brought into the light blocking state. In the following, a group of sub-apertures 200 brought into the light transmitting state within the reference parallax barrier pitch P are referred to as integrated apertures 300. In the example of FIG. 3, four sub-apertures 200 denoted by (1) to (4) are collectively referred to as the integrated apertures 300.

The integrated apertures 300 serve to guide each of light emitted from the left-eye sub-pixel 40b and light emitted from the right-eye sub-pixel 40a to directions different from each other. Although the integrated apertures 300 consisting of four sub-apertures 200 in the light transmitting state are formed on the left half of the reference parallax barrier pitch P in FIG. 3, the position of the integrated apertures 300 can be changed by changing the sub-apertures 200 to be brought into the light transmitting state.

Here, operation of the display device 1 will be briefly described.

The detector 31 detects a motion of the observer. The controller 32 controls the position of the integrated apertures 300 by controlling the light transmitting state or the light blocking state of each sub-aperture 200 in the parallax barrier shutter panel 20 based on a detection result obtained by the detector 31. Specifically, when the position of the observer moves in the short-side direction, the controller 32 moves the position of the integrated apertures 300 in the short-side direction in accordance with the movement. As a result, the observer can continuously see a stereoscopic image even when the observer moves in the short-side direction.

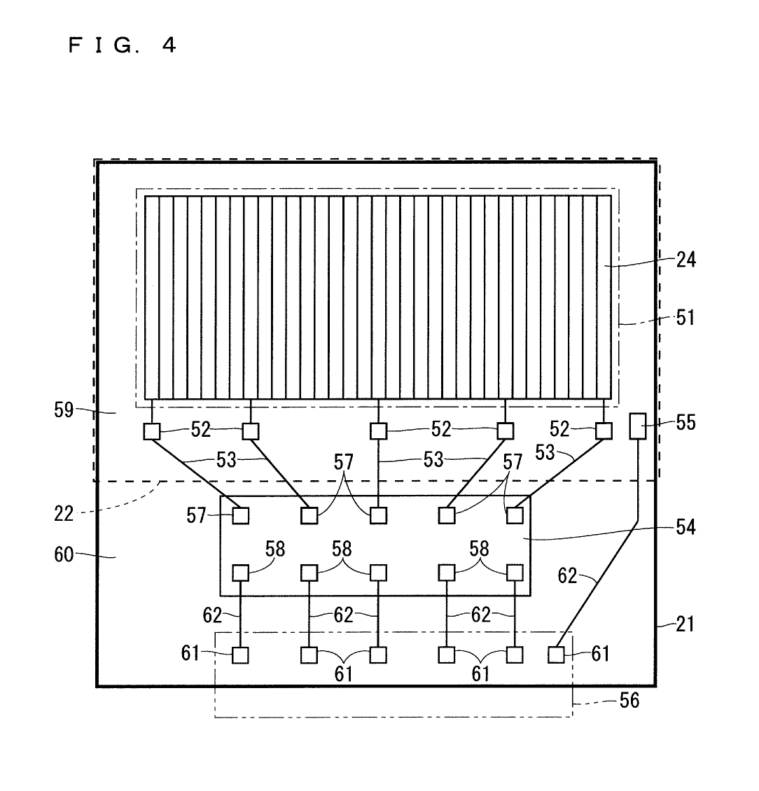

Next, the first transparent substrate 21 will be described. FIG. 4 is a plan view illustrating one example of a configuration of the first transparent substrate 21 according to the underlying technology.

As illustrated in FIG. 4, the first transparent substrate 21 includes a display area 51 including the sub-apertures 200, a frame area 59 provided to surround the display area 51, and a mounting area 60 where a drive IC 54, a flexible printed circuit (FPC) 56, etc. are mounted.

In the display area 51, the first transparent electrodes 24 are disposed to correspond to the sub-apertures 200. For example, the first transparent electrode 24 is formed of indium tin oxide (ITO) or the like.

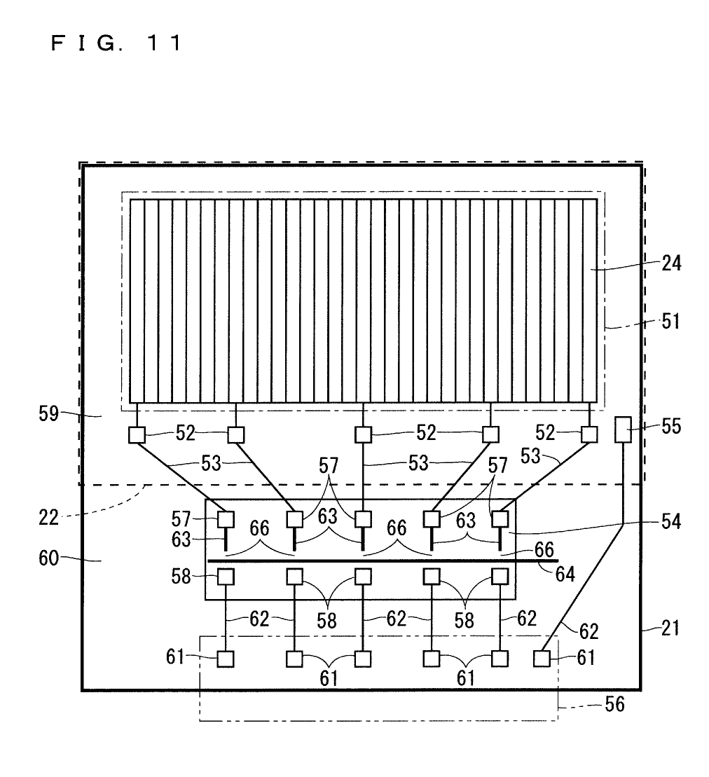

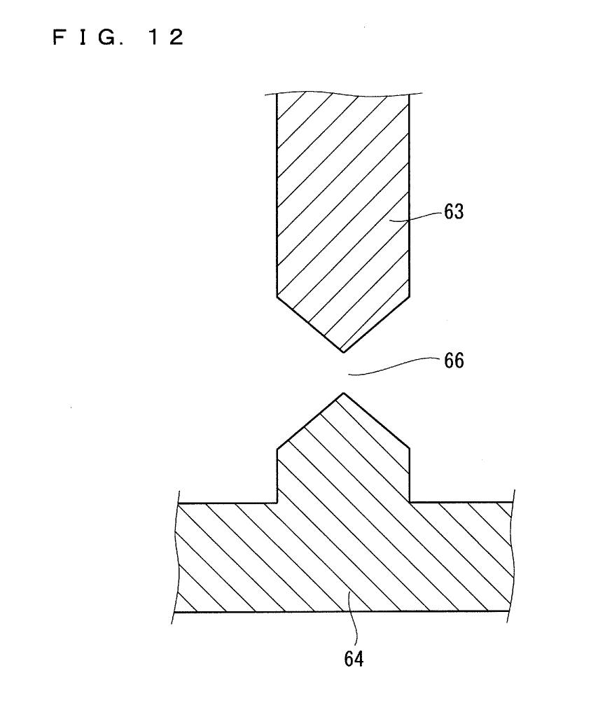

In the frame area 59, a plurality of routing wires 53, a plurality of converters 52, and a counter-substrate connection electrode 55 are formed. Here, the converter 52 will be described. Although not illustrated in detail in FIG. 4, for example, as illustrated in FIGS. 12 and 13 of Japanese Patent Application Laid-Open No. 2016-191890, a wire is routed from each first transparent electrode 24 in the first transparent substrate 21, and the wires are short-circuited for every eighth wire in each predetermined block. The short circuit portion corresponds to the converter 52. Therefore, the same drive voltage is input from one routing wire 53 to the first transparent electrode 24 for every eighth wire via the converter 52.

In the mounting area 60, drive IC output terminals 57, drive IC input terminals 58, and FPC terminals 61 are formed. The drive IC output terminal 57 is connected to the first transparent electrodes 24 via the routing wire 53 and the converter 52. The drive IC input terminal 58 is connected to the FPC terminal 61 via an input wire 62. The counter-substrate connection electrode 55 is connected to the FPC terminal 61 via another input wire 62.

For example, the routing wire 53 and the input wire 62 are formed of metal with a high melting point, metal with low resistance, an alloy film containing the metal with a high melting point or the metal with low resistance as a main component, or a stacked film made up of any combination of the metal with a high melting point, the metal with low resistance, and the alloy film. Examples of the metal with a high melting point and the metal with low resistance include chromium (Cr), aluminum (Al), tantalum (Ta), titanium (Ti), molybdenum (Mo), tungsten (W), nickel (Ni), copper (Cu), gold (Au), and silver (Ag).

In the first transparent substrate 21 according to the underlying technology illustrated in FIG. 4, for example, the routing wire 53 or the input wire 62 may be disconnected when static electricity is input to any of the drive IC output terminal 57, the drive IC input terminal 58, and the FPC terminal 61. This is a factor leading to reduction in a manufacturing yield of the display device 1.

Preferred embodiments of the present invention are achieved in order to solve the problems as described above, and will be described in detail below.

### FIRST PREFERRED EMBODIMENT

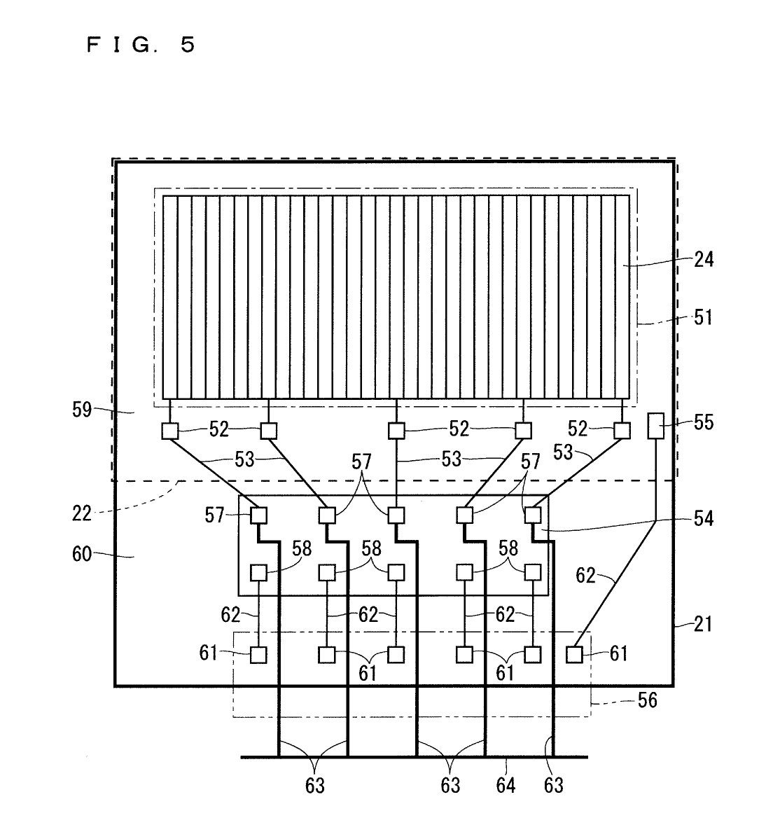

FIG. 5 is a plan view illustrating one example of a configuration of the first transparent substrate 21 according to a first preferred embodiment of the present invention.

As illustrated in FIG. 5, connection wires 63 are formed to extend from respective drive IC output terminals 57 to the outside of the first transparent substrate 21. A short ring 64 is formed outside the first transparent substrate 21. The first preferred embodiment is characterized in that each drive IC output terminal 57 is connected to the short ring 64 via the connection wire 63. Other configuration is the same as the configuration of the underlying technology, and therefore detailed description is herein omitted.

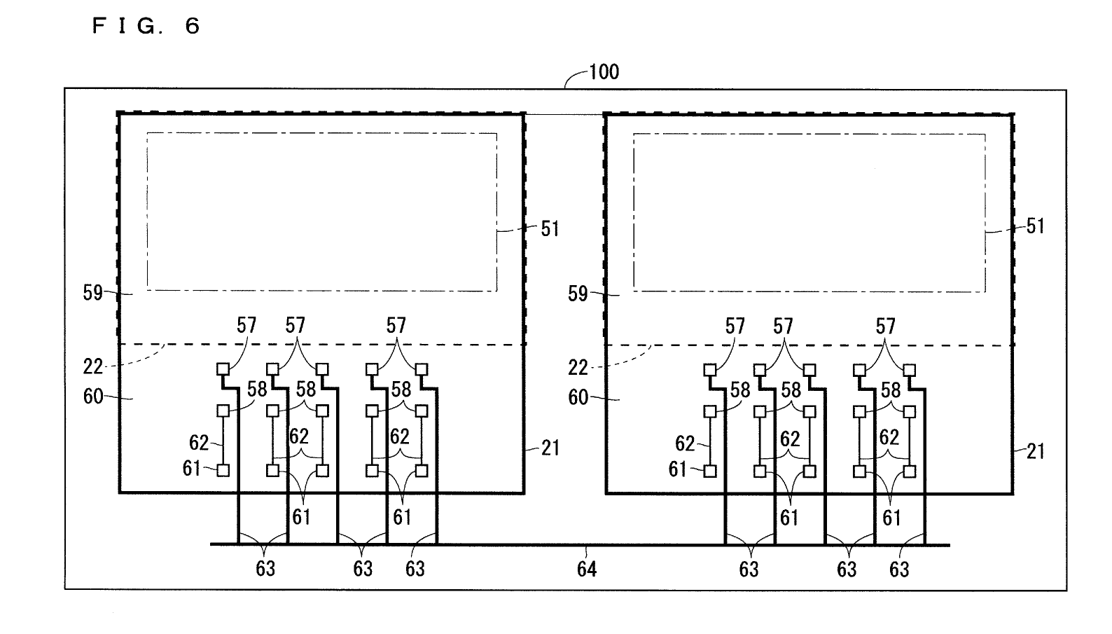

FIG. 5 illustrates a manufacturing process of the display device 1, specifically, a manufacturing process of the parallax barrier shutter panel 20. In the manufacturing process of the parallax barrier shutter panel 20, a plurality of first transparent substrates 21 are formed on a TFT array substrate 100 as illustrated in FIG. 6, for example. Note that the short ring 64 is formed to be shared by the plurality of first transparent substrates 21 in the example of FIG. 6, whereas the short ring 64 is separately formed to correspond to each first transparent substrate 21 in the example of FIG. 5. As illustrated in FIG. 6, the short ring 64 is formed on the TFT array substrate 100 outside the first transparent substrates 21.

When the first transparent substrate 21 is cut off to be removed from the TFT array substrate 100, the connection wires 63 are also cut off. With this, when the drive IC 54 and the FPC 56 are mounted later, each drive IC output terminal 57 is electrically isolated and is therefore not affected by the short ring 64 at the time of operation of the drive IC 54.

Note that, as illustrated in FIG. 6, the short ring 64 may be formed to be shared by the plurality of first transparent substrates 21 on the TFT array substrate 100 outside the first transparent substrates 21.

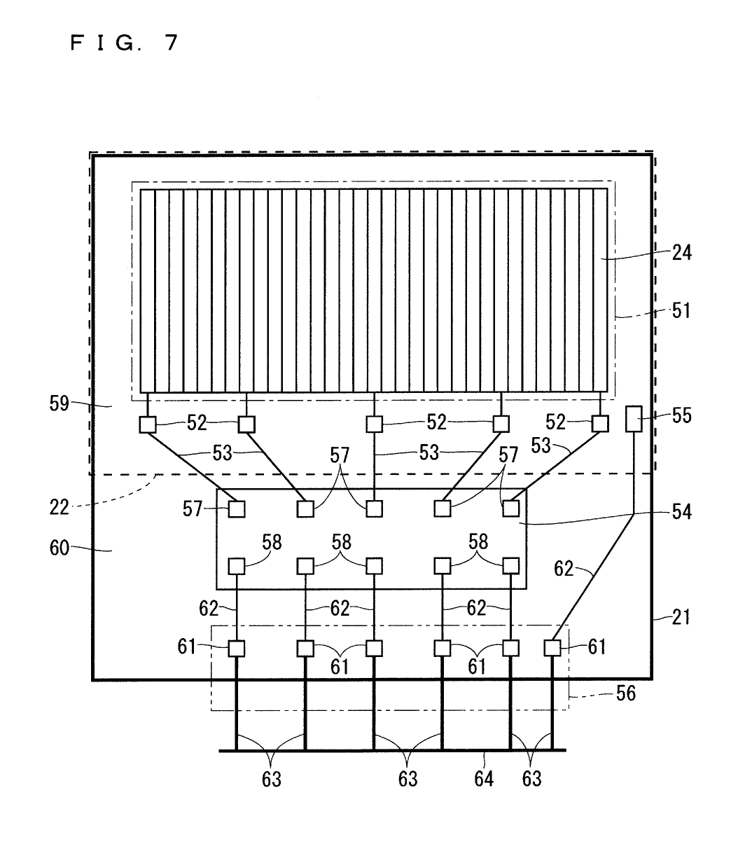

As illustrated in FIG. 7, each FPC terminal 61 and the short ring 64 may be connected via the connection wire 63.

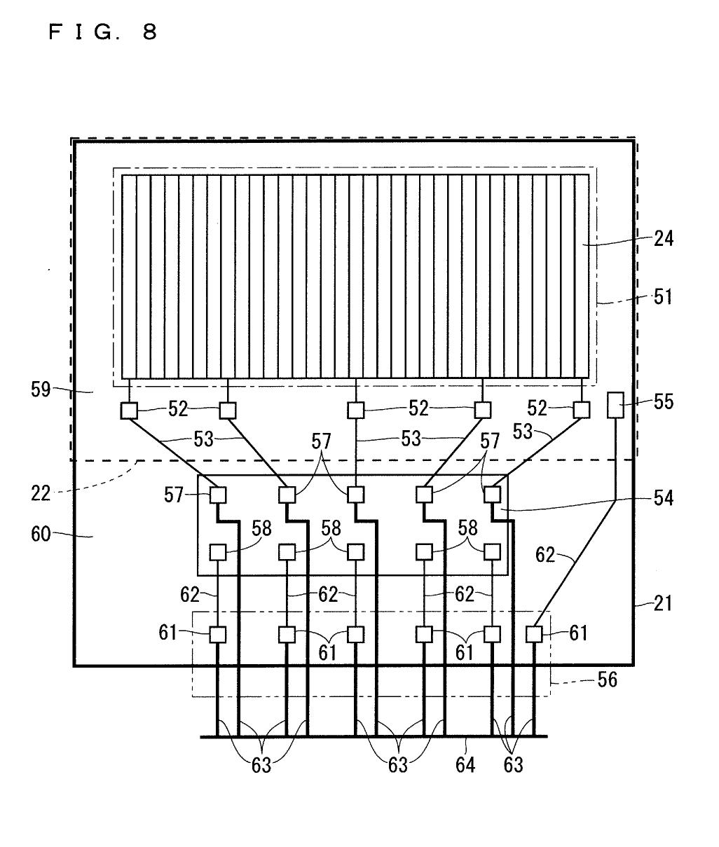

As illustrated in FIG. 8, each drive IC output terminal 57 and the short ring 64, and each FPC terminal 61 and the short ring 64 may be connected via the connection wire 63.

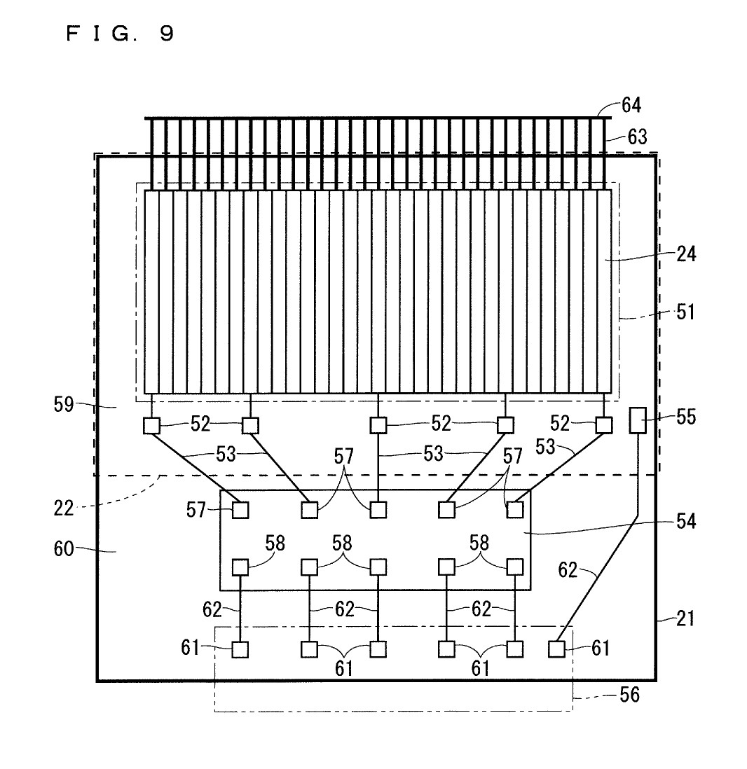

As illustrated in FIG. 9, each first transparent electrode 24 and the short ring 64 may be connected via the connection wire 63.

From the description above, according to the first preferred embodiment, in the manufacturing process of the parallax barrier shutter panel 20, at least one of each drive IC output terminal 57, each FPC terminal 61, and each first transparent electrode 24 is connected to the short ring 64 via the connection wire 63. Therefore, even when static electricity is input to any of each drive IC output terminal 57, each drive IC input terminal 58, and each FPC terminal 61, the static electricity is discharged via the short ring 64. Consequently, disconnection of the routing wires 53 or the input wires 62 can be prevented. With this, a manufacturing yield of the display device 1 can be enhanced.

### SECOND PREFERRED EMBODIMENT

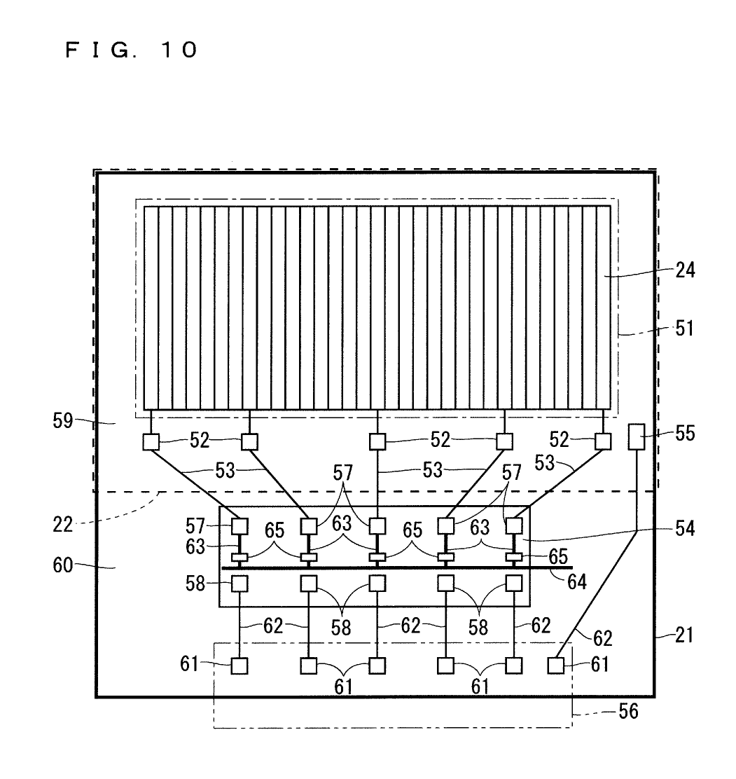

FIG. 10 is a plan view illustrating one example of a configuration of the first transparent substrate 21 according to a second preferred embodiment of the present invention.

As illustrated in FIG. 10, the short ring 64 is formed inside the first transparent substrate 21. The second preferred embodiment is characterized in that a high-resistance element 65 is provided between each drive IC output terminal 57 and the short ring 64. Specifically, each drive IC output terminal 57 is connected to the short ring 64 via the connection wire 63 and the high-resistance element 65. Other configuration is the same as the configuration of the underlying technology, and therefore detailed description is herein omitted.

For example, the high-resistance element 65 can be formed by a fine pattern of a high-resistance material, such as amorphous silicon or ITO.

From the description above, according to the second preferred embodiment, the high-resistance element 65 is provided between each drive IC output terminal 57 and the short ring 64. Therefore, each drive IC output terminal 57 is connected in such a degree as not to have influence when being driven, and also serves to prevent static electricity. With this, a manufacturing yield of the display device 1 can be enhanced.

Note that the high-resistance element 65 can be applied to the configurations illustrated in FIGS. 5, 7, 8, and 9 described in the first preferred embodiment. Specifically, in FIG. 5, the high-resistance element 65 may be provided between each drive IC output terminal 57 and the short ring 64. In FIG. 7, the high-resistance element 65 may be provided between each FPC terminal 61 and the short ring 64. In FIG. 8, the high-resistance element 65 may be provided between each drive IC output terminal 57 and the short ring 64 and between each FPC terminal 61 and the short ring 64. In FIG. 9, the high-resistance element 65 may be provided between each first transparent electrode 24 and the short ring 64. Also in such configurations, a manufacturing yield of the display device 1 can be enhanced.

Further, a configuration of further providing the high-resistance element 65 between the drive IC output terminals 57, between the converters 52, between the routing wires 53, or between the first transparent electrodes 24, for example, is more effective.

### THIRD PREFERRED EMBODIMENT

FIG. 11 is a plan view illustrating one example of a configuration of the first transparent substrate 21 according to a third preferred embodiment of the present invention.

As illustrated in FIG. 11, the short ring 64 is formed inside the first transparent substrate 21. The third preferred embodiment is characterized in that a spark gap 66 is provided between each drive IC output terminal 57 and the short ring 64. Specifically, each drive IC output terminal 57 is connected to the short ring 64 via the connection wire 63 and the spark gap 66. Other configuration is the same as the configuration of the underlying technology, and therefore detailed description is herein omitted.

As illustrated in FIG. 12, the spark gap 66 is a clearance provided between the connection wire 63 and the short ring 64.

From the description above, according to the third preferred embodiment, the spark gap 66 is provided between each drive IC output terminal 57 and the short ring 64. Therefore, even when static electricity is input to each drive IC output terminal 57, the static electricity is discharged via the spark gaps 66 and the short ring 64. Consequently, disconnection of the routing wires 53 or the input wires 62 can be prevented. With this, a manufacturing yield of the display device 1 can be enhanced.

Note that the spark gap 66 can be applied to the configurations illustrated in FIGS. 5, 7, 8, and 9 described in the first preferred embodiment. Specifically, in FIG. 5, the spark gap 66 may be provided between each drive IC output terminal 57 and the short ring 64. In FIG. 7, the spark gap 66 may be provided between each FPC terminal 61 and the short ring 64. In FIG. 8, the spark gap 66 may be provided between each drive IC output terminal 57 and the short ring 64 and between each FPC terminal 61 and the short ring 64. In FIG. 9, the spark gap 66 may be provided between each first transparent electrode 24 and the short ring 64. Also in such configurations, a manufacturing yield of the display device 1 can be enhanced.

Further, a configuration of further providing the spark gap 66 between the drive IC output terminals 57, between the converters 52, between the routing wires 53, or between the first transparent electrodes 24, for example, is more effective.

### FOURTH PREFERRED EMBODIMENT

FIG. 13 is a plan view illustrating one example of a configuration of the first transparent substrate 21 according to a fourth preferred embodiment of the present invention.

As illustrated in FIG. 13, the short ring 64 is formed inside the first transparent substrate 21. The fourth preferred embodiment is characterized in that a capacitor 67 is provided between each drive IC output terminal 57 and the short ring 64. Specifically, each drive 1C output terminal 57 is connected to the short ring 64 via the connection wire 63 and the capacitor 67. Other configuration is the same as the configuration of the underlying technology, and therefore detailed description is herein omitted.

For example, the capacitor 67 can be formed by overlapping the connection wire 63 and the short ring 64 with interposition of an insulation film.

From the description above, according to the fourth preferred embodiment, the capacitor 67 is provided between each drive IC output terminal 57 and the short ring 64. When capacitive coupling is realized between each drive IC output terminal 57 and the short ring 64 via the capacitor 64, an electric potential difference due to peeling electrification or the like is hardly generated between the drive IC output terminals 57. With this, a manufacturing yield of the display device 1 can be enhanced.

Note that the capacitor 67 can be applied to the configurations illustrated in FIGS. 5, 7, 8, and 9 described in the first preferred embodiment. Specifically, in FIG. 5, the capacitor 67 may be provided between each drive IC output terminal 57 and the short ring 64. In FIG. 7, the capacitor 67 may be provided between each FPC terminal 61 and the short ring 64. In FIG. 8, the capacitor 67 may be provided between each drive IC output terminal 57 and the short ring 64 and between each FPC terminal 61 and the short ring 64. In FIG. 9, the capacitor 67 may be provided between each first transparent electrode 24 and the short ring 64. Also in such configurations, a manufacturing yield of the display device 1 can be enhanced.

Further, a configuration of further providing the capacitor 67 between the drive IC output terminals 57, between the converters 52, between the routing wires 53, or between the first transparent electrodes 24, for example, is more effective.

### FIFTH PREFERRED EMBODIMENT

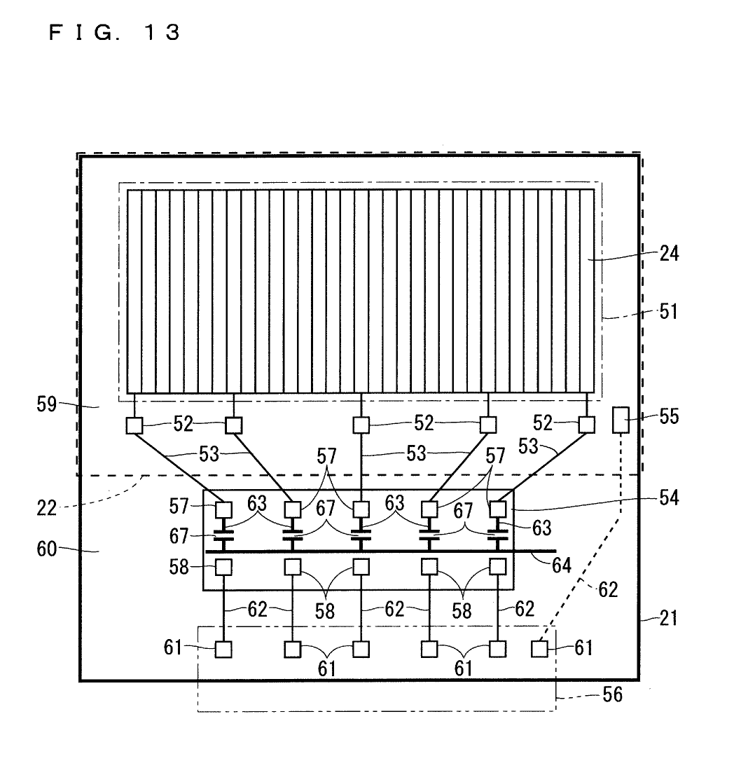

FIG. 14 is a cross-sectional view illustrating one example of a configuration of the first transparent substrate 21 according to a fifth preferred embodiment of the present invention.

As illustrated in FIG. 14, an electric-field shield transparent electrode 84 serving as an electric-field shield electrode is provided on the first transparent substrate 21 on the liquid crystal layer 23 side. A first insulation layer 81 is provided on the electric-field shield transparent electrode 84. Lower-layer transparent electrodes 24a and a first metal layer 87 are provided on the first insulation layer 81. The drive IC output terminal 57 is provided to be stacked on the first metal layer 87. A second insulation layer 82 is provided to cover the lower-layer transparent electrodes 24a, the first metal layer 87, and the drive IC output terminal 57. Upper-layer transparent electrodes 24b are provided on the second insulation layer 82. A third insulation layer 83 is provided to cover the upper-layer transparent electrodes 24b. A part of the drive IC output terminal 57 is exposed from the second insulation layer 82 and the third insulation layer 83.

The fifth preferred embodiment is characterized in that the electric-field shield transparent electrode 84 is provided on the first transparent substrate 21. Other configuration is the same as the configuration of the underlying technology, and therefore detailed description is herein omitted.

For example, the electric-field shield transparent electrode 84 can be formed of ITO or the like. Although the electric-field shield transparent electrode 84 is formed on the entire surface of the first transparent substrate 21 in FIG. 14, this configuration is not restrictive. For example, the electric-field shield transparent electrode 84 may be patterned so as not to be exposed on an end surface. Alternatively, although not illustrated, a wire extending from the FPC terminal 61 or the drive IC output terminal 57 may be electrically connected to the electric-field shield transparent electrode 84 such that an electric potential is applied to the electric-field shield transparent electrode 84. Further, for example, a portion (not shown) maintained to have a certain electric potential, such as a housing and a frame of the display device, and the electric-field shield transparent electrode 84 may be electrically connected. With this, the electric-field shield transparent electrode 84 is not floated, and therefore the shielding effect can be increased.

From the description above, according to the fifth preferred embodiment, the electric-field shield transparent electrode 84 is provided on the first transparent substrate 21. Consequently, an electric potential difference due to peeling electrification or the like is hardly generated between the drive IC output terminals 57. With this, a manufacturing yield of the display device 1 can be enhanced.

### SIXTH PREFERRED EMBODIMENT

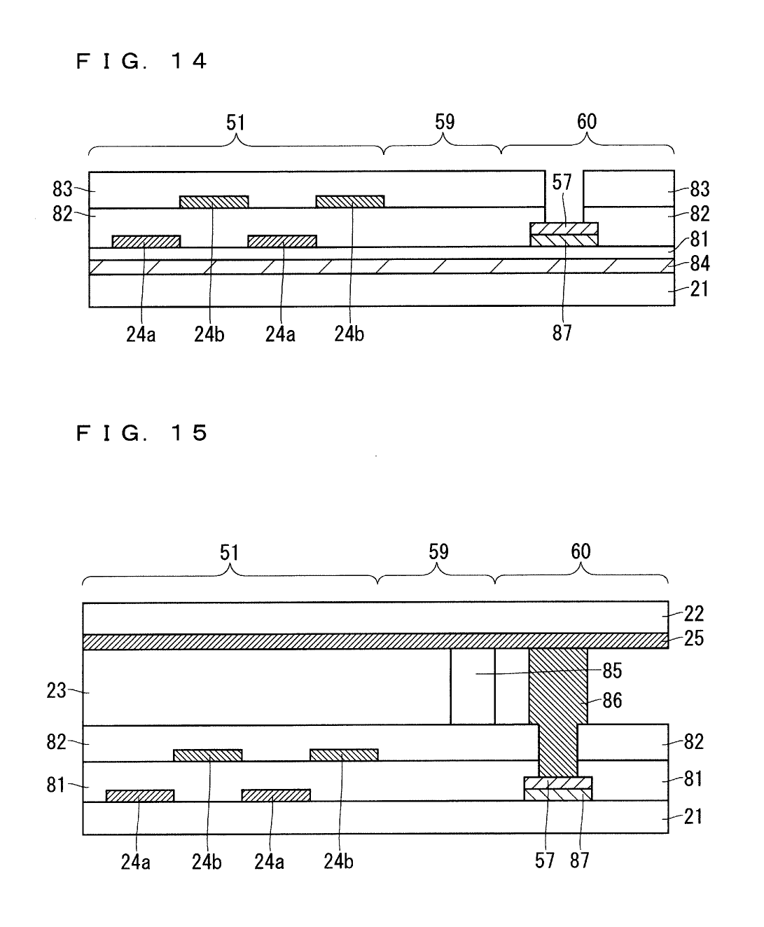

FIG. 15 is a cross-sectional view illustrating one example of a configuration of the parallax barrier shutter panel 20 according to a sixth preferred embodiment of the present invention. Note that FIG. 15 illustrates a manufacturing process of the display device 1, specifically, a manufacturing process of the parallax barrier shutter panel 20.

As illustrated in FIG. 15, the lower-layer transparent electrodes 24a and the first metal layer 87 are provided on the first transparent substrate 21 on the liquid crystal layer 23 side. The drive IC output terminal 57 is provided to be stacked on the first metal layer 87. The first insulation layer 81 is provided to cover the lower-layer transparent electrodes 24a, the first metal layer 87, and the drive IC output terminal 57. The upper-layer transparent electrodes 24b are provided on the first insulation layer 81. The second insulation layer 82 is provided to cover the upper-layer transparent electrodes 24b. A part of the drive IC output terminal 57 is exposed from the first insulation layer 81 and the second insulation layer 82. The second transparent electrode 25 is provided on the second transparent substrate 22 on the liquid crystal layer 23 side.

The liquid crystal layer 23 is sealed between the second insulation layer 82 and the second transparent electrode 25 by a seal 85. The drive IC output terminal 57 and the second transparent electrode 25 are electrically connected via a connection dummy seal 86. Note that, although one drive IC output terminal 57 and the second transparent electrode 25 are electrically connected via the connection dummy seal 86 in FIG. 15, other drive IC output terminals 57 are also electrically connected to the second transparent electrode 25 via respective connection dummy seals 86. When the first transparent substrate 21 is cut off to be removed from the TFT array substrate 100, the connection dummy seals 86 are also cut off.

The sixth preferred embodiment is characterized in that the drive IC output terminals 57 and the second transparent electrode 25 are electrically connected via the connection dummy seals 86. Other configuration is the same as the configuration of the underlying technology, and therefore detailed description is herein omitted.

The connection dummy seal 86 can be formed by mixing electrically conductive particles or the like into the seal 85. Examples of the electrically conductive particles include gold pearls etc.

From the description above, according to the sixth preferred embodiment, each drive IC output terminal 57 and the second transparent electrode 25 are electrically connected via the connection dummy seal 86 until the first transparent substrate 21 is cut off to be removed from the TFT array substrate 100. Consequently, the second transparent electrode 25 can be treated similarly to the short ring 64 described in the first to fourth preferred embodiments. Specifically, a manufacturing yield of the display device 1 can be enhanced.

Note that, although FIG. 15 describes a case where each drive IC output terminal 57 and the second transparent electrode 25 are electrically connected via the connection dummy seal 86, the configuration is not restrictive. For example, each drive IC input terminal 58 and the second transparent electrode 25 may be electrically connected via the connection dummy seal 86, and each FPC terminal 61 and the second transparent electrode 25 may be electrically connected via the connection dummy seal 86.

### SEVENTH PREFERRED EMBODIMENT

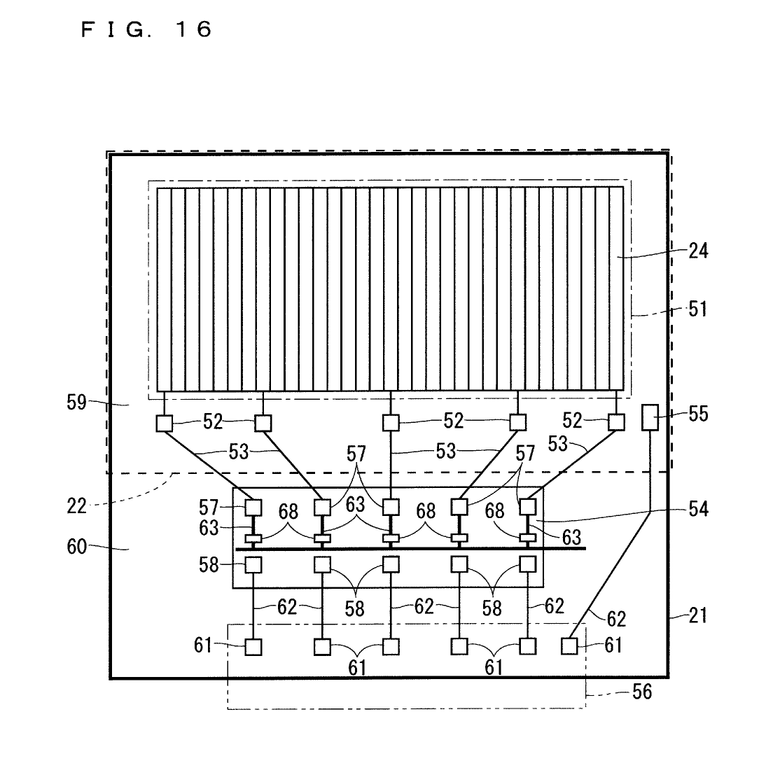

FIG. 16 is a plan view illustrating one example of a configuration of the first transparent substrate 21 according to a seventh preferred embodiment of the present invention.

As illustrated in FIG. 16, the short ring 64 is formed inside the first transparent substrate 21. The seventh preferred embodiment is characterized in that a non-linear element 68 is provided between each drive IC output terminal 57 and the short ring 64. Specifically, each drive IC output terminal 57 is connected to the short ring 64 via the connection wire 63 and the non-linear element 68. Other configuration is the same as the configuration of the underlying technology, and therefore detailed description is herein omitted.

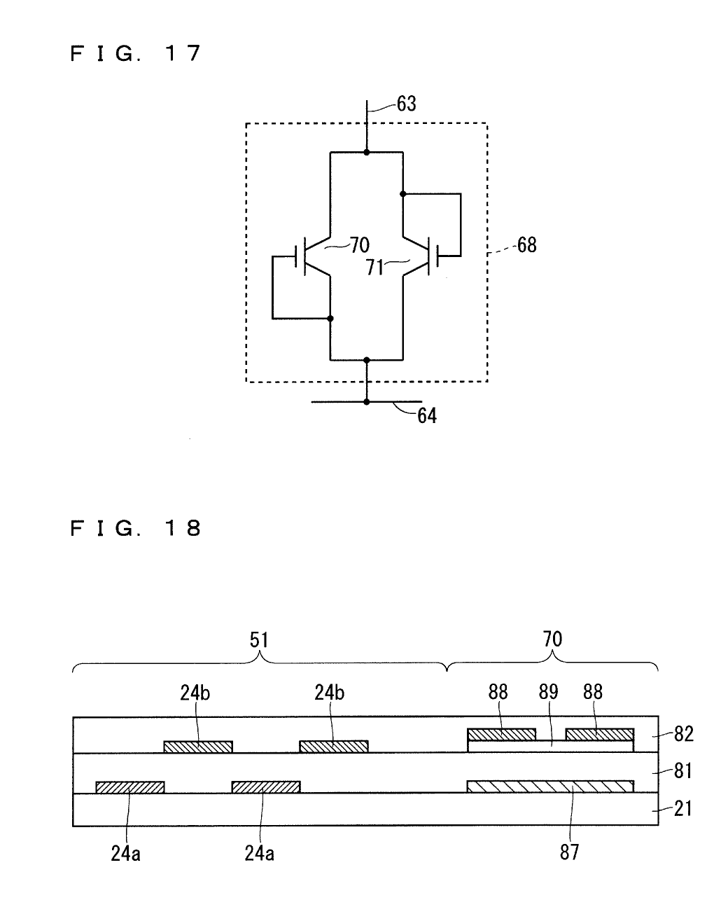

For example, as illustrated in FIG. 17, the non-linear element 68 can be formed by bidirectionally connecting a first transistor 70 and a second transistor 71 formed by using amorphous silicon, an oxide semiconductor, or the like.

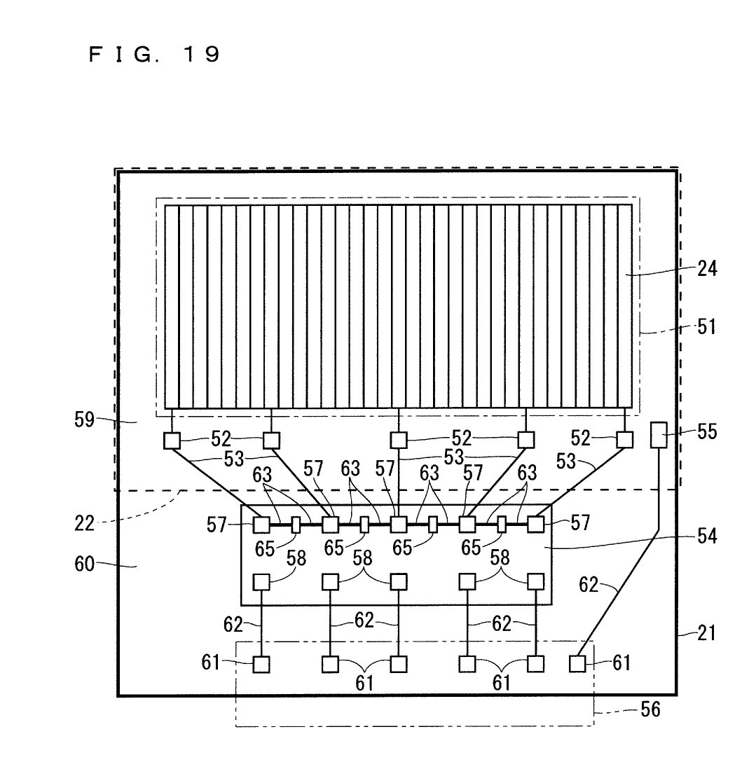

When an oxide semiconductor is used in the non-linear element 68, productivity of the parallax barrier shutter panel 20 is improved by imparting electrical conductivity to the first transparent electrode 24 to be a conductor and using the non-linear element 68 as a semiconductor. Examples of a method of imparting electrical conductivity to the first transparent electrode 24 include a method of depositing a film of an oxide semiconductor and then performing a hydrogen plasma treatment while only the display area 51 is exposed. FIG. 18 illustrates a cross-sectional view of the display area 51 and the first transistor 70 forming the non-linear element 68 in a case where an oxide semiconductor is used in the non-linear element 68. For example, in FIG. 18, a film of an oxide semiconductor is deposited on the first insulation layer 81, and then a hydrogen plasma treatment is performed while the display area 51 is exposed. Subsequently, processing is performed to obtain a desired pattern through a photolithography process, an etching process, etc. Consequently, the upper-layer transparent electrodes 24b and semiconductor layers 89 can be simultaneously formed.

From the description above, according to the seventh preferred embodiment, the non-linear element 68 is provided between each drive IC output terminal 57 and the short ring 64. Therefore, even when static electricity is input to each drive IC output terminal 57, the static electricity is discharged via the non-linear elements 68 and the short ring 64. Consequently, disconnection of the routing wires 53 or the input wires 62 can be prevented. With this, a manufacturing yield of the display device 1 can be enhanced.

Note that the non-linear element 68 can be applied to the configurations illustrated in FIGS. 5, 7, 8, and 9 described in the first preferred embodiment. Specifically, in FIG. 5, the non-linear element 68 may be provided between each drive IC output terminal 57 and the short ring 64. In FIG. 7, the non-linear element 68 may be provided between each FPC terminal 61 and the short ring 64. In FIG. 8, the non-linear element 68 may be provided between each drive IC output terminal 57 and the short ring 64 and between each FPC terminal 61 and the short ring 64. In FIG. 9, the non-linear element 68 may be provided between each first transparent electrode 24 and the short ring 64. Also in such configurations, a manufacturing yield of the display device 1 can be enhanced.

Further, a configuration of further providing the non-linear element 68 between the drive IC output terminals 57, between the converters 52, between the routing wires 53, or between the first transparent electrodes 24, for example, is more effective.

### EIGHTH PREFERRED EMBODIMENT

The second to seventh preferred embodiments describe a mode in which the short ring 64 and a surge voltage buffer, such as the high-resistance element 65, the spark gap 66, the capacitor 67, or the non-linear element 68, are provided in the parallax barrier shutter panel 20, and the first transparent electrodes 24 are connected to each other via the surge voltage buffer and the short ring 64. The eighth preferred embodiment is characterized in that the short ring 64 is omitted, and that the surge voltage buffer is provided between adjacent first transparent electrodes 24.

FIG. 19 is a plan view illustrating one example of a configuration of the first transparent substrate 21 according to the eighth preferred embodiment of the present invention. As illustrated in FIG. 19, the eighth preferred embodiment is characterized in that the high-resistance element 65 is provided between adjacent drive IC output terminals 57. Specifically, adjacent drive IC output terminals 57 are connected via the connection wire 63 and the high-resistance element 65.

In the second to seventh preferred embodiments, an electric charge in each first transparent electrode 24 is discharged via the short ring 64. In contrast, in the eighth preferred embodiment, there is no electric discharge via the short ring. However, an electric charge is shared by adjacent first transparent electrodes 24 via the high-resistance element 65, and thus an effect of reducing damage due to static electricity is achieved.

Although tolerance against static electricity in the eighth preferred embodiment is lowered as compared to the modes including the short ring, adopting the eighth preferred embodiment is meaningful when the short ring cannot be provided for the reason of pattern designing or the like.

Note that, although FIG. 19 describes a mode in which the high-resistance element 65 is provided between adjacent drive IC output terminals 57, a mode of providing any one of the spark gap 66, the capacitor 67, and the non-linear element 68 instead of the high-resistance element 65 also brings about the same effect as the effect described above.

### First Modification

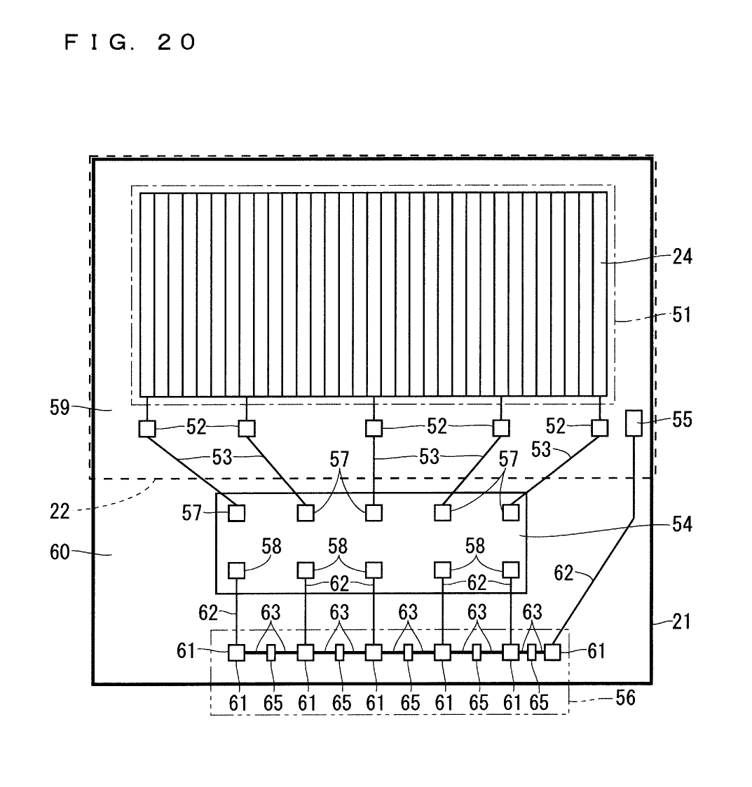

FIG. 20 is a plan view illustrating one example of a configuration of the first transparent substrate 21 according to a first modification of the eighth preferred embodiment. As illustrated in FIG. 20, the first modification is characterized in that the high-resistance element 65 is provided between adjacent FPC terminals 61. Specifically, adjacent FPC terminals 61 are connected via the connection wire 63 and the high-resistance element 65.

The first modification is the same as the eighth preferred embodiment in the omission of the short ring, but is different in the positions where the high-resistance elements 65 are provided. The first modification has a higher effect of reducing damage done to the drive IC 54 by inflow of an electric charge from each FPC terminal 61 to the drive IC input terminal 58, rather than the effect of discharging an electric charge in each first transparent electrode 24.

Note that, although FIG. 20 describes a mode in which the high-resistance element 65 is provided between adjacent FPC terminals 61, a mode of providing any one of the spark gap 66, the capacitor 67, and the non-linear element 68 instead of the high-resistance element 65 also brings about the same effect as the effect described above.

### Second Modification

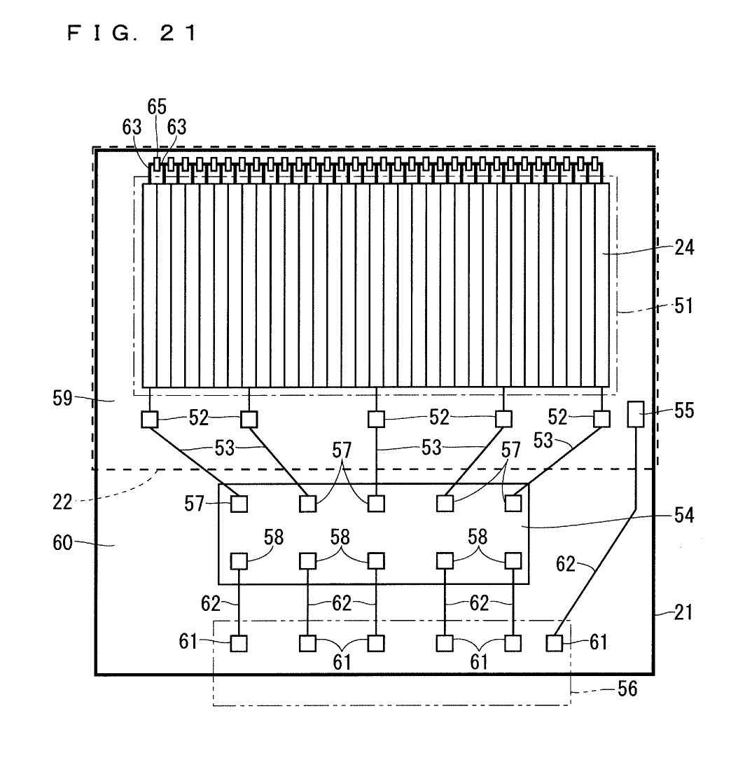

FIG. 21 is a plan view illustrating one example of a configuration of the first transparent substrate 21 according to a second modification of the eighth preferred embodiment. As illustrated in FIG. 21, the second modification is characterized in that the high-resistance element 65 is provided between adjacent first transparent electrodes 24. Specifically, adjacent first transparent electrodes 21 are connected via the connection wire 63 and the high-resistance element 65.

The second modification is the same as the eighth preferred embodiment in the omission of the short ring, but is different in the positions where the high-resistance elements 65 are provided. In the second modification, the high-resistance elements 65 are provided on a side where the converters 52 of the first transparent electrodes 21 are not provided, i.e., on a side opposed to the converters 52 with respect to the display area 51. The second modification also brings about the same effect as the effect of the eighth preferred embodiment. Further, it is usually difficult to provide the high-resistance elements 65 in a region where the converters 52 are provided because the region does not have space. However, the second modification does not have such a limitation, and can provide the high-resistance elements 65.

Note that, although FIG. 21 describes a mode in which the high-resistance element 65 is provided between adjacent first transparent electrodes 24, a mode of providing any one of the spark gap 66, the capacitor 67, and the non-linear element 68 instead of the high-resistance element 65 also brings about the same effect as the effect described above.

Note that, in the present invention, each of the embodiments may be freely combined, and each of the embodiments may be modified or omitted as appropriate within the scope of the invention.

While the invention has been shown and described in detail, the foregoing description is in all aspects illustrative and not restrictive. It is therefore understood that numerous modifications and variations can be devised without departing from the scope of the invention.

What is claimed is:

1. A display device comprising:
a display panel; and
a parallax barrier shutter panel provided to be opposed to the display panel, wherein
the parallax barrier shutter panel comprises:
a plurality of transparent electrodes provided at regular intervals;
a drive IC configured to control a voltage to be applied to each of the plurality of transparent electrodes; and
an FPC including an FPC terminal electrically connected to an input terminal of the drive IC, and
at least one of each of the plurality of transparent electrodes, an output terminal of the drive IC, and the FPC terminal is electrically connected to a short ring.

2. The display device according to claim 1, wherein
the parallax barrier shutter panel further comprises a high-resistance element between the short ring and at least one of each of the plurality of transparent electrodes, the output terminal of the drive IC, and the FPC terminal.

3. The display device according to claim 2, wherein
the high-resistance element is also provided between the plurality of transparent electrodes.

4. The display device according to claim 2, wherein
the drive IC comprises a plurality of the output terminals electrically connected to the plurality of transparent electrodes, and a plurality of the input terminals,
the FPC comprises a plurality of the FPC terminals electrically connected to the respective plurality of the input terminals, and
the high-resistance element is provided in a position of at least one of between the plurality of the output terminals and between the plurality of the FPC terminals.

5. The display device according to claim 1, wherein
the parallax barrier shutter panel further comprises a spark gap between the short ring and at least one of each of the plurality of transparent electrodes, the output terminal of the drive IC, and the FPC terminal.

6. The display device according to claim 5, wherein
the spark gap is also provided between the plurality of transparent electrodes.

7. The display device according to claim 5, wherein
the drive IC comprises a plurality of the output terminals electrically connected to the plurality of transparent electrodes, and a plurality of the input terminals,
the FPC comprises a plurality of the FPC terminals electrically connected to the respective plurality of the input terminals, and
the spark gap is provided in a position of at least one of between the plurality of the output terminals and between the plurality of the FPC terminals.

8. The display device according to claim 1, wherein
the parallax barrier shutter panel further comprises a capacitor between the short ring and at least one of each of the plurality of transparent electrodes, the output terminal of the drive IC, and the FPC terminal.

9. The display device according to claim 8, wherein
the capacitor is also provided between the plurality of transparent electrodes.

10. The display device according to claim 8, wherein
the drive IC comprises a plurality of the output terminals electrically connected to the plurality of transparent electrodes, and a plurality of the input terminals,
the FPC comprises a plurality of the FPC terminals electrically connected to the respective plurality of the input terminals, and
the capacitor is provided in a position of at least one of between the plurality of the output terminals and between the plurality of the FPC terminals.

11. The display device according to claim 1, wherein
the parallax barrier shutter panel further comprises a non-linear element between the short ring and at least one of each of the plurality of transparent electrodes, the output terminal of the drive IC, and the FPC terminal.

12. The display device according to claim 11, wherein
the non-linear element is also provided between the plurality of transparent electrodes.

13. The display device according to claim 11, wherein
the drive IC comprises a plurality of the output terminals electrically connected to the plurality of transparent electrodes, and a plurality of the input terminals,
the FPC comprises a plurality of the FPC terminals electrically connected to the respective plurality of the input terminals, and
the non-linear element is provided in a position of at least one of between the plurality of the output terminals and between the plurality of the FPC terminals.

14. The display device according to claim 1, wherein
the short ring is provided inside the parallax barrier shutter panel.

15. The display device according to claim 1, wherein
a plurality of the parallax barrier shutter panels are provided on one substrate, and
the short ring is provided to be shared by each the plurality of the parallax barrier shutter panels on the substrate outside the plurality of the parallax barrier shutter panels.

16. A display device comprising:
a display panel; and
a parallax barrier shutter panel provided to be opposed to the display panel, wherein
the parallax barrier shutter panel comprises:
a transparent substrate;
an electric-field shield electrode provided on the transparent substrate;
an insulation layer provided to cover the electric-field shield electrode; and
a plurality of transparent electrodes provided on the insulation layer at regular intervals.

17. A display device comprising:
a display panel; and
a parallax barrier shutter panel provided to be opposed to the display panel, wherein
the parallax barrier shutter panel comprises:
a plurality of transparent electrodes provided at regular intervals;
a drive IC configured to control a voltage to be applied to each of the plurality of transparent electrodes; and
an FPC including an FPC terminal electrically connected to an input terminal of the drive IC,
the drive IC comprises a plurality of the output terminals electrically connected to the plurality of transparent electrodes, and a plurality of the input terminals,
the FPC comprises a plurality of the FPC terminals electrically connected to the respective plurality of the input terminals, and
the parallax barrier shutter panel further comprises a high-resistance element between the plurality of transparent electrodes, the plurality of the output terminals, and the plurality of the FPC terminals.

18. The display device according to claim 17, wherein
the parallax barrier shutter panel further comprises a converter between the plurality of transparent electrodes and the plurality of the output terminals, and
the high-resistance element is provided between the plurality of transparent electrodes on a side opposed to the converter with respect to the plurality of transparent electrodes.

19. The display device according to claim 17, wherein
the parallax barrier shutter panel comprises a spark gap, a capacitor, or a non-linear element, instead of the high-resistance element.

20. A method of manufacturing a display device, the method comprising:
(a) preparing a display panel; and
(b) providing a parallax barrier shutter panel to be opposed to the display panel, wherein
the step (b) further comprises:
(c) forming a plurality of transparent electrodes on a transparent substrate at regular intervals;
(d) forming an input terminal and an output terminal of a drive IC on the transparent substrate, the drive IC being configured to control a voltage to be applied to each of the plurality of transparent electrodes;
(e) forming an FPC terminal on the transparent substrate, the FPC terminal being electrically connected to the input terminal of the drive IC;
(f) electrically connecting a short ring formed on the transparent substrate outside the parallax barrier shutter panel and at least one of each of the plurality of transparent electrodes, the output terminal of the drive IC, and the FPC terminal; and
(g) cutting off the electrical connection made in the step (f), and removing the parallax barrier shutter panel from the transparent substrate.

21. The method of manufacturing a display device according to claim 20, wherein
the step (b) further comprises (h) forming a non-linear element between the short ring and at least one of each of the plurality of transparent electrodes, the output terminal of the drive IC, and the FPC terminal.

22. The method of manufacturing a display device according to claim 21, wherein
in the step (h), the non-linear element is processed to be a semiconductor, and each of the plurality of transparent electrodes is processed to be a conductor.

23. The method of manufacturing a display device according to claim 20, wherein
before the step (c), the step (b) further comprises:
(i) forming an electric-field shield electrode on the transparent substrate; and
(j) forming an insulation layer to cover the electric-field shield electrode,
in the step (c), the plurality of transparent electrodes are formed on the insulation layer,
in the step (d), the input terminal and the output terminal are formed on the insulation layer, and
the electric-field shield electrode is electrically connected to the FPC terminal or the output terminal.

24. A method of manufacturing a display device, the method comprising:
(a) preparing a display panel; and
(b) providing a parallax barrier shutter panel to be opposed to the display panel, wherein
the step (b) further comprises:
(c) forming a plurality of transparent electrodes on a first transparent substrate at regular intervals;
(d) forming an input terminal and an output terminal of a drive IC on the first transparent substrate, the drive IC being configured to control a voltage to be applied to each of the plurality of transparent electrodes;
(e) forming an FPC terminal on the first transparent substrate, the FPC terminal being electrically connected to the input terminal of the drive IC;
(f) forming a second transparent electrode on a second transparent substrate opposed to the first transparent substrate;
(g) electrically connecting the second transparent electrode and at least one of the input terminal of the drive IC, the output terminal of the drive IC, and the FPC terminal; and
(h) cutting off the electrical connection made in the step (g), and removing the parallax barrier shutter panel from the first transparent substrate and the second transparent substrate.
